(19) United States
(12) Patent Application Publication
(10) Pub. No.: US 2015/0110650 A1
(43) Pub. Date: Apr. 23, 2015

(54) EXHAUST-GAS TURBOCHARGER

(71) Applicant: BorgWarner Inc., Auburn Hills, MI (US)

(72) Inventor: Ralf Christmann, Kaiserslautern (DE)

(21) Appl. No.: 14/398,141

(22) PCT Filed: Apr. 29, 2013
(86) PCT No.: PCT/US2013/038590

§ 371 Date: Oct. 31, 2014

(30) Foreign Application Priority Data
May 11, 2012 (DE) 102012009441.8

(51) Int. Cl. G01P 3/26; F04D 25/04

(52) U.S. Cl. CPC G01P 3/26; F04D 25/04
USPC 417/406; 73/521

(57) ABSTRACT

An exhaust-gas turbocharger (1) with a housing (2), a shaft (3) mounted in the housing (2), a compressor wheel (5) which is arranged on the shaft (3) and which has a plurality of blades (6), and a turbine wheel (4) which is arranged on the shaft (3) and which has a plurality of blades (6), with a rotary measurement arrangement having a pressure sensor (8), wherein the pressure sensor (8) is arranged to detect pressure fluctuations (10) in the gas at the compressor wheel (5) or turbine wheel (4).

The invention relates to an exhaust-gas turbocharger according to the preamble of claim 1.

An exhaust-gas turbocharger normally comprises a housing in which a shaft is mounted. A turbine wheel and a compressor wheel are arranged rotationally conjointly on the shaft. The turbine wheel is set in rotation by means of exhaust gas. The shaft and the compressor wheel rotate with the turbine. Charge air in the accommodating chamber of the compressor wheel is thereby compressed. In exhaust-gas turbochargers, it is sometimes necessary to determine the rate of rotation or rotational speed.

It is an object of the present invention to specify an exhaust-gas turbocharger which, while being inexpensive to produce and operable with low maintenance, permits a precise measurement of the rotational speed and/or of the rate of rotation. It is also an object of the present invention to specify a method for measuring rotational speed or rate of rotation in the exhaust-gas turbocharger.

The object is achieved by the features of the independent claims. The dependent claims relate to preferred refinements of the invention.

According to the invention, a pressure sensor is used in the exhaust-gas turbocharger. Extremely small pressure fluctuations are measured by means of said pressure sensor. Said pressure fluctuations arise as a result of the blades of the compressor wheel or of the turbine wheel passing the pressure sensor. It is particularly preferable for the pressure sensor to be mounted at the compressor wheel, and thus for the pressure fluctuations at the compressor wheel to be measured. It is alternatively also possible for the pressure fluctuation to be measured at the turbine wheel by means of the pressure sensor. The rotational speed and thus also the rate of rotation can be determined from the pressure fluctuation, which is dependent on the number of blades.

When the blades of the compressor wheel or of the turbine wheel pass the pressure sensor, they alternately generate a pressure rise (also: pressure peak) and a subsequent pressure drop (also: pressure trough). A blade can be unequivocally detected when a pressure rise exceeds a certain pressure threshold value. The rotational speed and/or the rate of rotation can thus be determined on the basis of the number of blades. Here, both the rotational speed and also the rate of rotation of the shaft, of the compressor wheel and of the turbine wheel are always equal.

Further details, advantages and features of the present invention become apparent from the following description of an exemplary embodiment with reference to the drawing, in which:

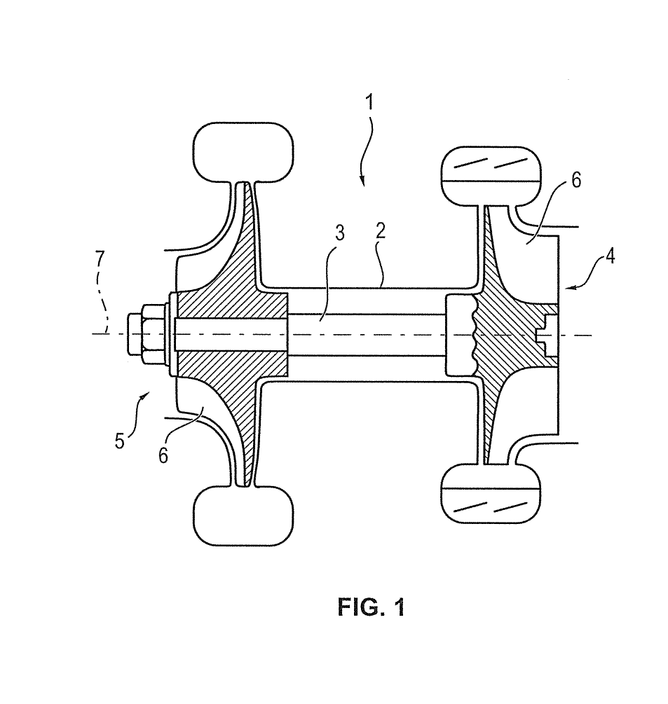

FIG. 1 shows a simplified schematic view of an exhaust-gas turbocharger according to the invention as per the exemplary embodiment,

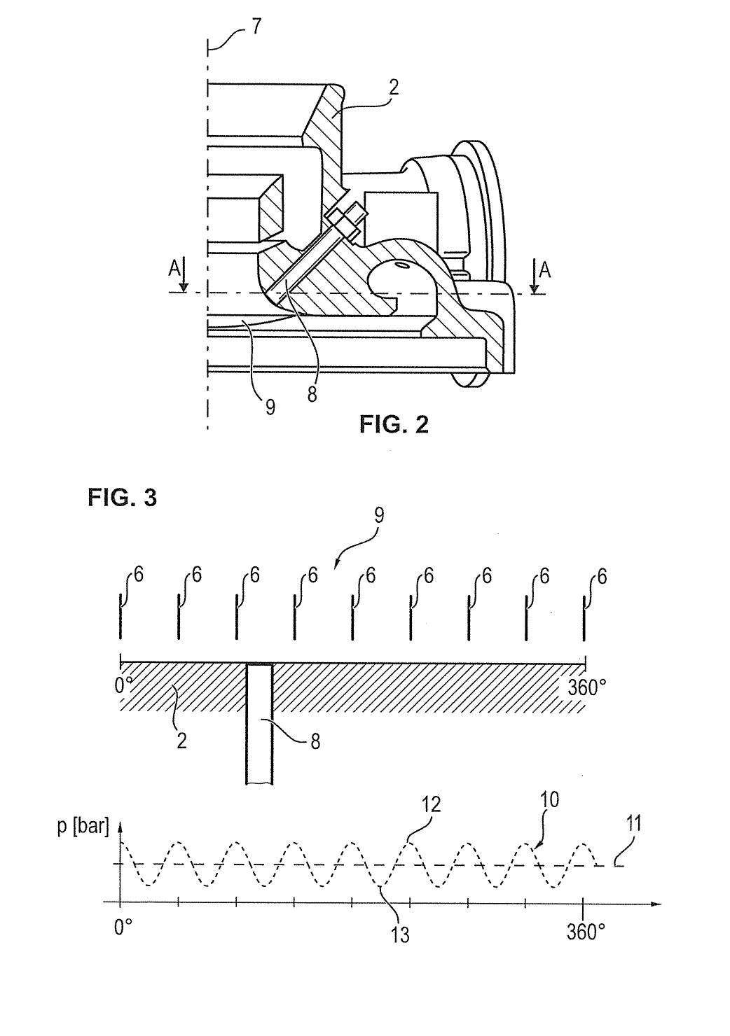

FIG. 2 shows a detail of the exhaust-gas turbocharger according to the invention as per the exemplary embodiment, and

FIG. 3 shows a developed section from FIG. 2 and an associated pressure profile.

An exemplary embodiment of the exhaust-gas turbocharger 1 according to the invention will be explained in detail below on the basis of FIGS. 1 to 3.

FIG. 1 shows a simplified schematic view of the main components of the exhaust-gas turbocharger 1. The exhaust-gas turbocharger 1 comprises a housing 2 in which a shaft 3 is mounted. A turbine wheel 4 and a compressor wheel 5 are seated on the ends of the shaft 3. The turbine wheel 4 and the compressor wheel 5 are rotationally conjointly connected to the shaft 3. Both the turbine wheel 4 and also the compressor wheel 5 have blades 6. The shaft 3 extends along an axis 7.

FIG. 2 shows a detail of the exhaust-gas turbocharger 1. The illustration shows a part of the housing 2 with an accommodating chamber 9 for the compressor wheel 5.

A pressure sensor 8 is arranged in the housing 2. The pressure-sensitive part of the pressure sensor 8 measures the pressure in the accommodating chamber 9 of the compressor wheel. Here, the pressure sensor 8 is arranged perpendicular to the individual blades 6 of the compressor wheel 5.

A section A-A is labeled in FIG. 2. The upper illustration in FIG. 3 shows said section A-A in a simplified developed illustration. The horizontal axis illustrated in FIG. 3 indicates the development of the compressor wheel 5. Consequently, the entire circumference of the compressor wheel 5 from 0° to 360° is illustrated there. The individual blades 6 are illustrated above the horizontal axis. The housing 2 with the integrated pressure sensor 8 is situated below the horizontal axis.

A pressure profile or a pressure fluctuation 10 measured by the pressure sensor 8 is plotted in the lower part of FIG. 3. The pressure fluctuation 10 is formed from a sequence of pressure rises 12 and pressure drops 13. All values exceeding a pressure threshold value 11 are defined as a pressure rise 12 or as a pressure peak. It is preferably also possible for only values significantly higher than the pressure threshold value 11 to be identified as a pressure rise 12.

As can be seen from FIG. 3, each blade 6 which passes the pressure sensor 8 generates a pressure rise 12. Since the number of blades 6 is self-evidently known, it is possible, on the basis of the profile of the pressure fluctuation 10, to determine the rotational speed and the rate of rotation of the shaft 3, of the turbine wheel 4 and of the compressor wheel 5.

If one visualizes an imaginary observer at an arbitrary point along the contour perpendicular to the blades 6, the observer sees a pressure rise 12 or pressure peak coming towards him as the blade 6 approaches. Said pressure rise 12 reaches its maximum when the blade 6 is opposite the observer. The pressure sensor 8 is positioned in the place of said imaginary observer. The pressure rise 12 then decreases again until the next blade 6 approaches. A determination of the rotational speed is thus possible by means of a very fast and precise pressure measurement. By contrast to conventional eddy-current sensors, the pressure sensor always functions equally effectively regardless of the material of the compressor wheel 5 or of the turbine wheel 4. Specifically, the measurement principle is based only on flow processes. Furthermore, the rotation measurement according to the invention is less sensitive with regard to the distance to the blades 6 than is the case with eddy-current sensors.

In addition to the above written description of the invention, reference is hereby explicitly made to the diagrammatic illustration of the invention in FIGS. 1 to 3 for additional disclosure thereof.

### LIST OF REFERENCE SIGNS

1 Exhaust-gas turbocharger
2 Housing
3 Shaft
4 Turbine wheel
5 Compressor wheel
6 Blades
7 Axis
8 Pressure sensor
9 Compressor wheel accommodating chamber
10 Pressure fluctuations
11 Pressure threshold value
12 Pressure rise (pressure peak)
13 Pressure drop (pressure trough)

1. An exhaust-gas turbocharger (1) comprising:
a housing (2),
a shaft (3) mounted in the housing (2),
a compressor wheel (5) which is arranged on the shaft (3) and which has a plurality of blades (6),
a turbine wheel (4) which is arranged on the shaft (3) and which has a plurality of blades (6), and
a rotary measurement arrangement having a pressure sensor (8), wherein the pressure sensor (8) is arranged to detect pressure fluctuations (10) in the gas at the compressor wheel (5) or turbine wheel (4).

2. The exhaust-gas turbocharger as claimed in claim 1, wherein each blade (6) passing the pressure sensor (8) generates a pressure rise (12) with a subsequent pressure drop (13), and the pressure sensor (8) is designed to detect the individual pressure rises (12) and pressure drops (13).

3. The exhaust-gas turbocharger as claimed in claim 1, further comprising a processing unit for calculating the rotational speed or rate of rotation of the shaft (3), of the compressor wheel (5) or of the turbine wheel (4) from the pressure fluctuations (10) and the number of blades (6).

4. The exhaust-gas turbocharger as claimed in claim 1, wherein the pressure sensor (8) is arranged in the housing (2) so as to be spaced apart from all rotating components.

5. The exhaust-gas turbocharger as claimed in claim 1, wherein the pressure sensor (8) is arranged perpendicular to the blades (6).

6. A method for determining a rotational speed or rate of rotation in an exhaust-gas turbocharger (1), comprising the following steps:
providing an exhaust-gas turbocharger (1) comprising a compressor wheel (5) with a plurality of blades (6) and a turbine wheel (4) with a plurality of blades (6),
detecting pressure fluctuations in the gas at the compressor wheel (5) or turbine wheel (4), and
calculating the rotational speed or rate of rotation of the compressor wheel (5) or turbine wheel (4) from the pressure fluctuations (10) and the number of blades (6).

7. The method as claimed in claim 6, wherein each blade (6) passing a measurement point generates a pressure rise (12) with a subsequent pressure drop (13), and the individual pressure rises (12) and pressure drops (13) are detected.
